(19) United States
(12) Patent Application Publication
(10) Pub. No.: US 2025/0006046 A1
(43) Pub. Date: Jan. 2, 2025

(54) INFORMATION PROVIDING DEVICE AND INFORMATION PROVIDING METHOD

(71) Applicant: HONDA MOTOR CO., LTD., Tokyo (JP)

(72) Inventor: Yoshiaki SUGIMOTO, Tokyo (JP)

(21) Appl. No.: 18/708,214

(22) PCT Filed: Oct. 25, 2022
(86) PCT No.: PCT/JP2022/039653

§ 371 Date: May 8, 2024

(30) Foreign Application Priority Data
Nov. 25, 2021 (JP) 2021-191241

(51) Int. Cl. G08G 1/01; G06F 21/62

(52) U.S. Cl. CPC G08G 1/0129; G06F 21/6245

(57) ABSTRACT

An information providing device 30 includes a communication unit 33 that receives location information of a plurality of vehicles 50; a storage unit 32 that stores map information including road maps; a departure/arrival point location information generating unit (for example, “departure/arrival point location information generating unit 313” described hereinafter) that accumulates the location information for discretely changing time for respective moving bodies, calculates a mode of the location information for the respective moving bodies, and generates, as departure/arrival point location information, plane information including the location information of the mode; and a location information outputting unit (for example, “location information outputting unit 314” described hereinafter) that, for each moving body of the plurality of moving bodies, outputs the plane information and also outputs the location information beyond a location separated by a prescribed distance from the position of the mode.

### TECHNICAL FIELD

The present disclosure relates to an information provider and an information providing method for performing various information analyses on a mobile object such as an automobile or the like. The information provider and the information providing method provide position information of the mobile object such as the automobile or the like.

### BACKGROUND ART

In the related art, a technology is known which acquires position information of a mobile object such as an automobile or the like and, based on a plurality of pieces of the position information of the mobile object that are acquired, performs various analyses on a route by which the mobile object has traveled, a facility at which the mobile object stays, and the like. For example, Patent Document 1 discloses a technology that, by analyzing probe information that is output from a portable terminal that travels together with a mobile object, specifies a travel route of the mobile object, a position of a start point of the travel route, and a position of an end point of the travel route. Based on the travel route and the positions of the start point and the end point that are specified, it is possible to analyze from which start point and through which travel route the mobile object visited a facility (for example, a station) that serves as the end point, and display analysis results of the analysis. A user who refers to the analysis results can know the travel route of each person who visited the facility (for example, a station) that serves as the end point. By using the technology or the like disclosed in Patent Document 1, it is possible to display the start point and the travel route traveled by each person who visited the facility that serves as the end point, as described above. However, the technology disclosed in Patent Document 1 is problematic in that, by displaying the travel route and the start point when a person visits a facility, personal information such as a position of a home and a position of a company of the person who visited the facility can be estimated, and in a case of performing such analysis, it is important to protect personal information of each individual mobile object (for example, home position information and workplace position information).

In this respect, Patent Document 2 (Japanese Patent No. 6721532) discloses a technology that, by displaying, for a vehicle that visits a facility, position information that changes at discrete times in a superimposed manner with map information at a predetermined transparency, generates analysis information capable of notifying accurate analysis results while protecting personal information.

### CITATION LIST

### Patent Document

Patent Document 1: Japanese Unexamined Patent Application, Publication No. 2015-76005
Patent Document 2: Japanese Patent No. 6721532

### DISCLOSURE OF THE INVENTION

### Problems to be Solved by the Invention

However, in a case of analyzing a certain amount of position information of a mobile object, the technology described in Patent Document 2 is capable of anonymizing position information of the mobile object that is in a home vicinity that serves as a departure point or arrival point, but in a case in which the amount of position information of the mobile object becomes large, the position in the home vicinity may become visible. For that reason, in order for such a technology to be widely used as an analysis tool, the technology needs to be more considerate of the protection of personal information of a mobile object.

The present disclosure is made in view of the above circumstances, and an object of the present disclosure is to provide an information provider and an information providing method that are capable of generating position information of a mobile object such as an automobile or the like and providing the position information to a user who performs various analyses, while protecting personal information.

### Means for Solving the Problems

In a first aspect, an information provider according to the present disclosure (for example, an information provider 30 that is described later), including: a receiver (for example, a receiver 311 that is described later) that is configured to receive position information of a plurality of mobile objects (for example, a vehicle 50 that is described later);
a storage (for example, a storage 32 that is described later) that is configured to store map information that includes a road map;
a departure/arrival point position information generator (for example, a departure/arrival point position information generator 313 that is described later) that is configured, for the plurality of mobile objects, to accumulate, for each mobile object of the plurality of mobile objects, the position information that changes discretely over time, calculate, for each mobile object of the plurality of mobile objects, a highest frequency value for the position information for each mobile object, and generate, as departure/arrival point position information, surface information that includes position information of a position that has the highest frequency value; and
a position information outputter (for example, a position information outputter 314 that is described later) that is configured, for the plurality of mobile objects, to output, for each mobile object of the plurality of mobile objects, the surface information and output the position information of a position that is separated, from a position that has the highest frequency value, by a predetermined distance or greater and subsequent positions following the position.

According to the first aspect, it is possible to obtain an advantageous effect of providing accurate vehicle position information and can withstand various analyses, while protecting position information that relates to personal information of a home vicinity of a user of a mobile object.

In a second aspect, in the information provider according to the first aspect, the surface information may be a mesh of a predetermined area or greater.

According to the second aspect, it is possible to obtain an advantageous effect in that it is possible to further protect personal information.

In a third aspect, in the information provider according to the first aspect, the surface information may be an administrative section.

According to the third aspect, it is possible to obtain an advantageous effect in that it is possible to further protect personal information.

In a fourth aspect, in the information provider according to any one of the first to third aspects, the position that is separated by the predetermined distance or greater from the position that has the highest frequency value may be a position that is separated from the surface information.

According to the fourth aspect, it is possible to obtain an advantageous effect in that it is possible to protect personal information even further.

In a fifth aspect, in the information provider according to any one of the first to fourth aspects, the position information outputter is configured to output, in a superimposed manner on the map information, the surface information and the position information of the positions that are separated, from the position that has the highest frequency value, by the predetermined distance or greater and subsequent positions following the position.

According to the fifth aspect, it is possible to obtain an advantageous effect in that it is possible to make vehicle position information of the mobile object visible on a map while protecting position information that relates to the personal information of the home vicinity of the user of the mobile object.

In a sixth aspect, an information providing method according to the present disclosure that is performed by a computer (for example, the information provider 30 that is described later), the method including:
a receiving step of receiving position information of a plurality of mobile objects (for example, the vehicle 50 that is described later);
a storing step of storing map information that includes a road map;
a departure/arrival point position information generating step of, for the plurality of mobile objects, accumulating, for each mobile object of the plurality of mobile objects, the position information that changes discretely over time, calculating, for each mobile object of the plurality of mobile objects, a highest frequency value for the position information for each mobile object, and generating, as departure/arrival point position information, surface information that includes position information of a position that has the highest frequency value; and
a position information outputting step of, for the plurality of mobile objects, outputting, for each mobile object of the plurality of mobile objects, the surface information and outputting the position information of a position that is separated, from a position that has the highest frequency value, by a predetermined distance or greater and subsequent positions following the position.

According to the sixth aspect, it is possible to obtain an advantageous effect that is the same as the information provider according to the first aspect.

### Effects of the Invention

According to the present disclosure, it is possible to provide accurate vehicle position information that can be used for various analyses while protecting the position information that relates to the personal information of the home vicinity of the user of the mobile object.

### BRIEF DESCRIPTION OF THE DRAWINGS

FIG. 1 is a block diagram that illustrates an overall basic configuration of an information providing system according to an embodiment of the present disclosure;

FIG. 2 is a functional block diagram that illustrates a functional configuration of a vehicle-mounted navigation apparatus according to an embodiment of the present disclosure;

FIG. 3 is a functional block diagram that illustrates a functional configuration of a portable terminal according to an embodiment of the present disclosure;

FIG. 4 is a functional block diagram that illustrate a functional configuration of an information provider according to an embodiment of the present disclosure;

FIG. 5 is a diagram that illustrates an example of a position information database according to an of the present disclosure;

FIG. 6 is a diagram that illustrates an example of a departure/arrival point position information table according to an embodiment of the present disclosure;

FIG. 7 is a diagram that illustrates an example of a display of travel route information with protected personal information according to an embodiment of the present disclosure;

FIG. 8 is a flowchart that illustrates an operation of generating, for one mobile object (vehicle 50), surface information according to an embodiment of the present disclosure; and

FIG. 9 is a flowchart that illustrates an operation of generating, for one mobile object (vehicle 50), travel route information with protected personal information according to an embodiment of the present disclosure.

### PREFERRED MODE FOR CARRYING OUT THE INVENTION

The following describes in detail, with reference to the drawings, a preferred embodiment of an information providing system of the present disclosure.

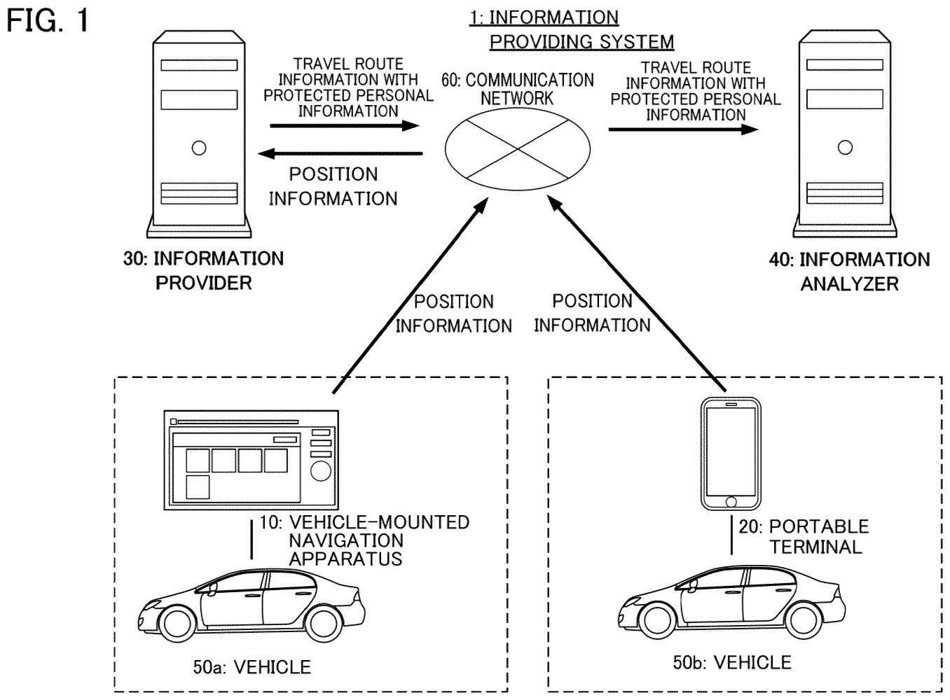

The following describes the information providing system 1 according to the preferred embodiment of the present disclosure. FIG. 1 illustrates an overall configuration of the information providing system 1.

As indicated in FIG. 1, the information providing system 1 includes a vehicle-mounted navigation apparatus 10, a portable terminal 20, and an information provider 30. The apparatus, terminal, and information provider are communicably connected to each other via a communication network 60. In addition, the information providing system 1 may include an information analyzer 40. The figures also illustrate information that is transmitted and received by the apparatuses and the terminals, and the information is merely an example. In the preferred embodiment of the present disclosure, information other than information that is illustrated may be transmitted and received.

The vehicle-mounted navigation apparatus 10 is an apparatus that performs navigation (route guidance) for a user who rides in a vehicle 50a. Further, the vehicle-mounted navigation apparatus 10 also has a function of positioning position information of the vehicle-mounted navigation apparatus 10 (that is, position information of the vehicle 50a). The vehicle-mounted navigation apparatus 10 performs route guidance from a current position to a destination based on a request of the user who rides in the vehicle 50 and position information that has been positioned.

Further, the vehicle-mounted navigation apparatus 10 appropriately transmits, to the information provider 30, the position information that has been positioned as well as a mobile object ID and date/time information that are identification information that identifies the vehicle-mounted navigation apparatus 10. Here, the vehicle-mounted navigation apparatus 10 and the vehicle 50a are used as a set that is one-to-one, and thus the position information to be transmitted to the information provider 30 can be substantially regarded as the position information of the vehicle 50a. Such a vehicle-mounted navigation apparatus 10 can be achieved by a portable car navigation device installed in the vehicle 50a that is the mobile object or a portable navigation device (PND) that is easily mounted in the vehicle 50a that is the mobile object.

The portable terminal 20 is a portable terminal that is used by a user who rides in the vehicle 50b. In a similar manner to the vehicle-mounted navigation apparatus 10 described above, the portable terminal 20 has a function of performing navigation (route guidance) and a function of positioning position information of the portable terminal 20 (that is, position information of the vehicle 50b).

Moreover, in a similar manner to the vehicle-mounted navigation apparatus 10 described above, the portable terminal 20 appropriately transmits, to the information provider 30, the position information that has been positioned as well as the mobile object ID and the date/time information that are identification information that identifies the mobile terminal 20. Here, the portable terminal 20 and the vehicle 50b are used as a set that is one-to-one, and thus the position information to be transmitted to the information provider 30 can be substantially regarded as the position information of the vehicle 50b. Such a portable terminal 20 can be achieved by a smartphone, a cellular phone, a tablet terminal, a notebook computer, or other portable electronic devices.

In addition, the figures illustrate the set of the vehicle-mounted navigation apparatus 10 and the vehicle 50a and the set of the portable terminal 20 and the vehicle 50b. However, the number of such sets is not particularly limited, and the preferred embodiment of the present disclosure may include any number of the sets. Similarly, the number of the information provider 30 is not particularly limited, and any number of information providers 30 may be included in the preferred embodiment of the present disclosure.

Further, in the following description, in a case in which the vehicle 50a in which the vehicle-mounted navigation apparatus 10 is mounted or the vehicle 50b in which the user, who uses the portable terminal 20, rides, is referred to without distinction, the vehicle 50a and the vehicle 50b are referred to simply as the “vehicle 50”, with no letter. Furthermore, the vehicle 50 and the vehicle-mounted navigation apparatus 10 and the portable terminal 20 that are used in the vehicle 50 travel together with the vehicle 50. For that reason, in the following description, the vehicle 50, the vehicle-mounted navigation apparatus 10, and the portable terminal 20 are also referred to as the “mobile object” as appropriate.

The information provider 30 is an apparatus that is configured to generate and provide, for each vehicle 50, position information that can withstand various analyses and that changes at discrete times (hereinafter, also referred to as “vehicle position information with protected personal information”), while protecting position information that relates to personal information of a home vicinity of the user of each vehicle 50. Specifically, the information provider 30 protects, with surface information for example, the position information that relates to the personal information of the home vicinity of the user of each vehicle 50. As the position information of the vehicle 50 that changes at discrete times, the information provider 30 also generates and provides, for the vehicle 50, position information that changes at discrete times of a position that is separated by a predetermined distance or greater from the surface information or of a position that is separated, from home position information of the user of the vehicle, by a predetermined distance or greater and subsequent positions following the position. The details thereof are described later.

The information provider 30 includes a display device (not shown), and the vehicle position information with protected personal information that is generated may be displayed in a superimposed manner on the map information by being output to the display device. Further, by outputting (transmitting) the vehicle position information with protected personal information, to, for example, the information analyzer 40 that has various analyses functions, the information analyzer 40 may display, in a superimposed manner on the map information, the vehicle position information with protected personal information on a display device (not shown) such as a display. Further, the vehicle position information with protected personal information may be displayed, in a superimposed manner on the map information, on a terminal device (not shown) that is communicably connected to the information analyzer 40.

The information analyzer 40 is an apparatus that has a function of using the vehicle position information with protected personal information that is provided by the information provider 30 in various analyses. The information analyzer 40 can be achieved by, for example, a personal computer, a server, or the like. A description of the functions of the information analyzer 40 is omitted.

The vehicle 50 is a mobile object in which a user of the vehicle-mounted navigation apparatus 10 or the portable terminal 20 rides. The vehicle 50 can be achieved by, for example, a four-wheeled automobile, a motorcycle, a bicycle, or the like.

The communication network 60 is realized by a network such as the Internet, a cellular phone network, or a network obtained by combining these networks. Further, the communication network 60 may include, in part, a local Area Network (LAN) (for example, between the information providing apparatus 30 and the information analyzer 40). The following briefly describes the vehicle-mounted navigation apparatus 10 and the portable terminal 20 before describing the information provider 30.

The vehicle-mounted navigation apparatus 10 receives power from the vehicle 50a, and vehicle-mounted navigation apparatus 10 automatically activates when an ignition switch of the vehicle 50a is turned on (an engine is started) by the user who rides in the vehicle 50a. Moreover, the vehicle-mounted navigation apparatus 10 operates until the ignition switch of the vehicle 50a is turned off (the engine is stopped) by the user who rides in the vehicle 50a.

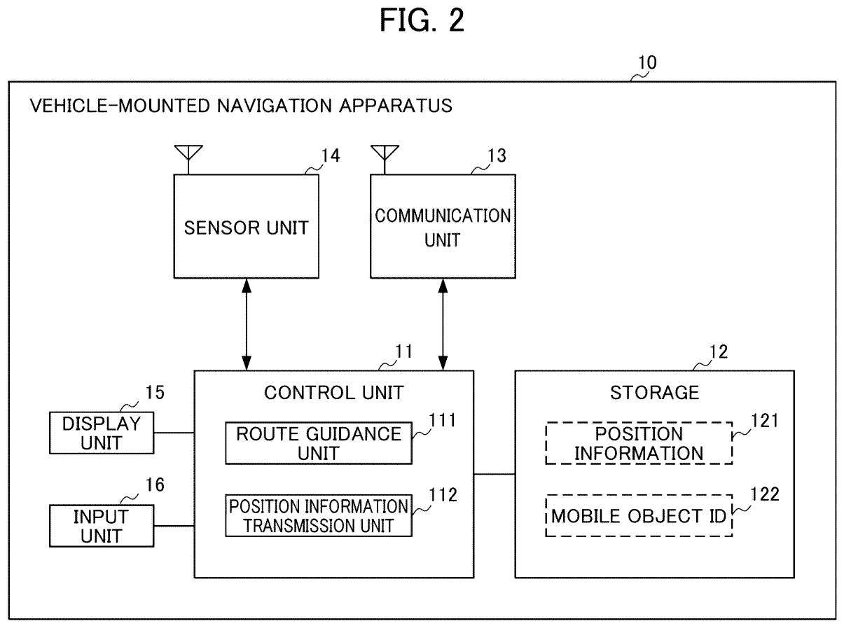

As illustrated in FIG. 2, the vehicle-mounted navigation apparatus 10 includes a control unit 11, a storage 12, a communication unit 13, a sensor unit 14, a display unit 15, and an input unit 16.

The control unit 11 includes an arithmetic processing unit such as a microprocessor, and controls each unit that constitutes the vehicle-mounted navigation apparatus 10. The details of the control unit 11 are described later.

The storage 12 is configured with a semiconductor memory or the like, and stores various information such as programs such as control programs called firmware and operating systems, programs that perform route guidance processing, and programs that perform a transmission process of the position information to the information provider 30, and also map information that includes facility information and facility IDs for route guidance.

The figure illustrates, as information that is stored in the storage 12, position information 121 and mobile object ID 122, that are information that particularly relates to the transmission process of the position information. The position information 121 is position information of the vehicle-mounted navigation apparatus 10 (that is, the position information of the vehicle 50a) that is positioned by the sensor unit 14 that is described later. The position information 121 may include not only information that indicates a position that is positioned, but also a time at which the position is positioned.

The mobile object ID 122 is information that identifies the vehicle-mounted navigation apparatus 10 or the vehicle 50a on which the vehicle-mounted navigation apparatus 10 is mounted. As the mobile object ID 122, it is possible to use, for example, a serial number or the like that is uniquely assigned to the vehicle-mounted navigation apparatus 10. In addition, in order for the communication unit 13 to connect to the communication network 60 that is a network such as a cellular phone network, it is possible to use, as the mobile object ID 122, a telephone number that is assigned to a subscriber identity module (SIM) that is inserted in the communication unit 13. In addition, it is possible to use, as the mobile object ID 122, a vehicle identification number (VIN) or a unique number plate number that is assigned to the vehicle 50a.

The communication unit 13 can be achieved by a digital signal processor (DSP) or the like, and realizes, in accordance with standards such as long-term evolution (LTE), 4th generation (4G), and 5th generation (5G) and standards such as Wi-Fi (registered trademark), wireless communication with another apparatus (for example, the information providing apparatus 30) via the communication network 60. The communication unit 13 is used to enable, for example, a position information transmission unit 112 that is described later, to transmit, to the information provider 30, the position information 121 and the mobile object ID 122 that is stored in the storage 12. Data transmitted and received between the communication unit 13 and the other apparatus is not particularly limited, and information other than the position information 121 and the mobile object ID 122 may be transmitted and received.

The sensor unit 14 is configured with, for example, a global positioning system (GPS) sensor, a gyro sensor, an acceleration sensor, and the like. The sensor unit 14 includes a function of a position detection means that detects position information. The sensor unit 14 also positions the position information (longitude and latitude) of the vehicle-mounted navigation apparatus 10 by a GPS sensor receiving GPS satellite signals. The positioning by the sensor unit 14 is performed, as described above, at a predetermined time interval (for example, three seconds). The position information that is positioned is stored in the storage 12 as the position information 121. The GPS sensor can position altitude in addition to longitude and latitude, and therefore the position information may include altitude in addition to longitude and latitude. The sensor unit 14 can, based on an angular velocity or the acceleration that are measured by the gyro sensor or the acceleration sensor, further increase a positioning accuracy of the position information of the vehicle-mounted navigation apparatus 10. The display unit 15 is configured with a display device such as a liquid crystal display, an organic electroluminescence panel, or the like. The display unit 15 is configured to display an image in response to an instruction from the control unit 11. The input unit 16 is configured with an input device (not shown) such as a physical switch called a numeric keypad, a touch screen that is provided on the display surface of the display unit 15, and the like. Although not shown, the vehicle-mounted navigation apparatus 10 may include a speaker, a microphone, or the like. The speaker outputs audio to a driver, and the microphone collects audio or the like emitted by the driver. By doing so, information can be output from the speaker by sound, and various selections and instructions that are input by the driver by sound via the microphone can be input to the control unit 11 by virtue of sound recognition technology.

Next, the following describes the control unit 11 in detail. The control unit 11 is configured with a microprocessor that has a Central Processing Unit (CPU), Random access memory (RAM), Read Only Memory (ROM), Input/Output (I/O), and the like. The CPU executes each program read from the ROM or the storage 12, and, during execution, reads information from the RAM, the ROM, and the storage 12, writes information to the RAM and the storage 12, and transmits and receives signals to and from the communication unit 13, the sensor unit 14, the display unit 15, and the input unit 16. Moreover, in this way, the hardware and the software (program) cooperate to achieve the processing in the preferred embodiment of the present disclosure.

The control unit 11 includes a route guidance unit 111 and the position information transmission unit 112 as functional blocks.

The route guidance unit 111 is a unit that is configured to perform route guidance processing to a destination such as a facility that is input or selected by a user. The route guidance unit 111 is well known to those skilled in the art, and thus a detailed description thereof is omitted.

The position information transmission unit 112 is configured to use the communication unit 13 to transmit, to the information provider 30 by virtue of wireless communication, the position information 121 and the mobile object ID 122 that are stored in the storage 12.

The transmission of the position information 121 and the mobile object ID 122 to the information providing apparatus 30 by the position information transmission unit 112 is periodically performed from when the ignition switch of the vehicle 50a is turned on (the engine is started) by the user, who rides in the vehicle 50a at a start of a drive, and the vehicle-mounted navigation apparatus 10 automatically activates until the ignition switch of the vehicle 50a is turned off (the engine is stopped) at an end of the drive. For example, every time the sensor unit 14 performs positioning at the predetermined time interval (for example, a three-second interval), transmission is performed in real time. That is, transmission is performed in real time from the start of the drive until the end of the drive. Further, instead of transmitting to the information provider 30 in real time, the position information transmission unit 112 may collect a plurality of pieces of information (for example, the position information 121 and the mobile object ID 122 that are updated at intervals of three seconds over a period of three minutes) and transmit them at the same time. That is, the position information transmission unit 112 may perform so-called burst transmission. The length of the predetermined time interval and whether transmission is performed in real time or as a burst transmission can be arbitrarily set according to an environment or the like that the preferred embodiment of the present disclosure is applied to. In this way, by performing real-time transmission or burst transmission, the position information transmission unit 112 transmits, to the information provider 30, the mobile object ID 122 and the position information 121 that specifies the travel route of the vehicle 50a that is positioned by the sensor unit 14.

In this case, the ignition switch is turned on (the engine is started), and a position that is specified in the position information 121 that is positioned immediately after the vehicle-mounted navigation apparatus 10 automatically activates can be transmitted to the information provider 30 as a first vehicle position in the drive, that is, a departure position. Furthermore, a position that is specified in the position information 121 that is positioned immediately before the ignition switch is turned off (the engine is stopped) can be transmitted to the information provider 30 as a final vehicle position in the drive, that is, a parking position. For example, information that indicates whether the position information 121 represents the departure position or the position information 121 represents the parking position (for example, setting a flag that indicates each of these positions to a value of one) is added to the position information 121 and then transmitted to the information provider 30. The position information 121 (that is, the parking position) that is positioned immediately before the ignition switch is turned off (the engine is stopped) may be transmitted when the ignition switch is turned on (the engine is started) and the vehicle-mounted navigation apparatus 10 is re-activated.

In addition, in a case in which burst transmission is performed, for example, in a case in which the route guidance unit 111 determines that the vehicle 50a has arrived at a destination such as a facility, the position information transmission unit 112 can switch to perform transmission in real time. In this way, it is possible to prevent a situation in which the ignition switch is turned off (the engine is stopped) after arrival at a destination such as a facility and before the position information 121 of the destination such as a facility is transmitted, resulting in position information transmission unit 112 failing to transmit the position information 121 of the destination such as a facility to the information provider 30.

Further, the position information transmission unit 112 can transmit, to the information provider 30, speed information of the vehicle 50a together with the position information 121 and the mobile object ID 122.

### Portable Terminal 20

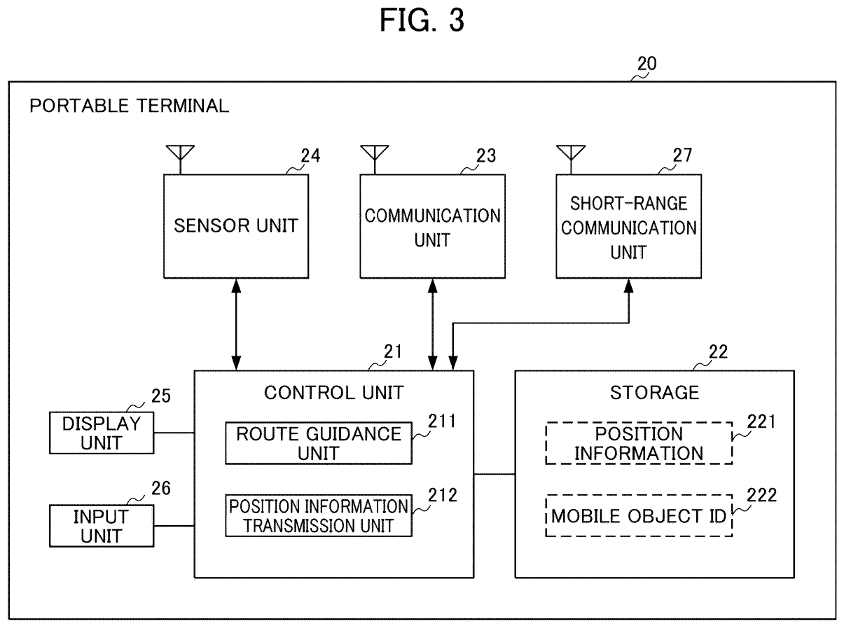

As shown in FIG. 3, the portable terminal 20 includes a control unit 21, a storage 22, a communication unit 23, a sensor unit 24, a display unit 25, an input unit 26, and a short-range communication unit 27. Here, the control unit 21, the storage 22, the communication unit 23, the sensor unit 24, the display unit 25, and the input unit 26 have functions that are equivalent to those of the functional blocks of the same names that are included in the vehicle-mounted navigation apparatus 10. In other words, descriptions of the functional blocks of the portable terminal 20 can be obtained by replacing, in the description of the vehicle-mounted navigation apparatus 10 described above, “vehicle-mounted navigation apparatus 10” with “portable terminal 20” and replacing “vehicle 50a” with “vehicle 50b”, and thus a repetition of overlapping descriptions is omitted.

On the other hand, the portable terminal 20 differs from the vehicle-mounted navigation apparatus 10 in that the portable terminal 20 includes the short-range communication unit 27, and thus the following describes the difference. The short-range communication unit 27 is configured to perform at least non-contact short-range communication in accordance with standards such as near field communication (NFC) and Bluetooth (registered trademark), or wireless short-range communication via a Universal Serial Bus (USB) cable.

On the other hand, the vehicle 50b includes a short-range communication unit that is configured to communicate with the short-range communication unit 27. For example, the vehicle 50b includes an electronic control unit (ECU), and the ECU includes a short-range communication unit. Moreover, a case in which the portable terminal 20 can communicate with the ECU by short-range communication refers to a case in which the portable terminal 20 is present in the vehicle 50b. In this case, the position information positioned by the sensor unit 24 of the portable terminal 20 corresponds to the position information of the vehicle 50b.

As such, the portable terminal 20 activates the position information transmission unit 212 while the portable terminal 20 can perform short-range communication with the ECU via the short-range communication unit 27. Moreover, similarly to the position information transmission unit 112 of the vehicle-mounted navigation apparatus 10, the position information transmission unit 212 that is activated transmits, to the information provider 30, the mobile object ID 122 and the position information 221 that specifies the travel route of the vehicle 50b that is positioned by the sensor unit 24.

For example, upon the user holding the portable terminal 20, riding in the vehicle 50b, and turning on an activation switch of the vehicle 50b such as an ignition switch, the vehicle 50b and the portable terminal 20 are connected (paired), and then the mobile object ID 222 and the position information 221 that is positioned by the portable terminal 20 are transmitted from the portable terminal 20 to the information provider 30. Furthermore, upon the activation switch of the vehicle 50b such as the ignition switch being turned off, the pairing between the vehicle 50b and the portable terminal 20 is released.

In a case in which the vehicle 50b has a function of positioning the position information, the position information positioned by the vehicle 50b may be transmitted, instead of the position information positioned by the sensor unit 24, to the information provider 30 as the position information 121. In this case, the sensor unit 24 may be omitted from the portable terminal 20.

By acquiring, from the vehicle-mounted navigation apparatus 10 or the portable terminal 20, the position information of each vehicle 50, the information provider 30 creates a position information database that is a database of the position information of each vehicle 50. Further, the information provider 30 stores map information that includes facility positions that relate to a plurality of facilities. Moreover, the information provider 30 generates accurate vehicle position information (hereinafter, also referred to as “vehicle position information with protected personal information”). The accurate vehicle position information is used to display, in a superimposed manner with map information, position information that changes at discrete times of a vehicle that visits a facility, while protecting, by the surface information, the position information that relates to the personal information of the home vicinity of the user of each vehicle 50. As described later for example, an administrative section, a mesh of a predetermined area or greater, or the like may be set in advance as the surface information. Further, the surface information may include home position information of a predetermined number or more of vehicle users in an area indicated by the surface information. In the vehicle position information with protected personal information, the position information of the vehicle 50 that changes at discrete times and displays the travel route may also be position information of the vehicle 50 that changes at discrete times of a position that is separated by a predetermined distance or greater from the surface information or of a position that is separated, from the home position information of the user of the vehicle, by a predetermined distance or greater and subsequent positions following the position. Moreover, the mobile object ID of the vehicle 50 is also converted into a random value (“converted mobile object ID”) by, for example, a one-way function. By doing so, the information provider 30 provides, as vehicle position information with protected personal information, travel route information that is specified based on the position information that changes at discrete times and is received for each travel of the mobile object for each mobile object ID that is converted.

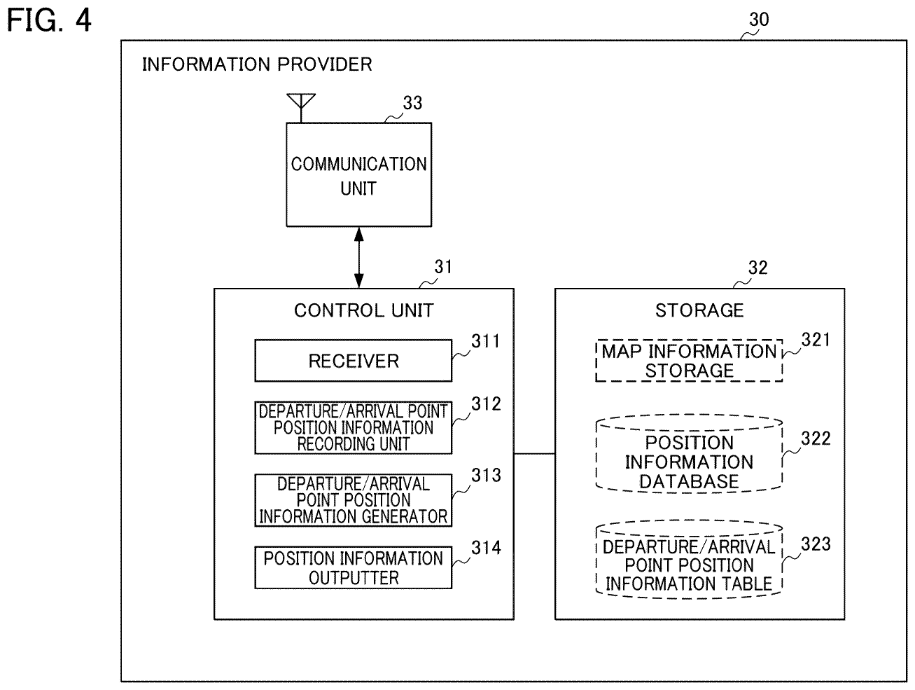

In this way, according to the vehicle position information with protected personal information, the personal information can be protected because it is difficult, for a user that uses the information, to visually recognize the position information of each position in the home vicinity of the user of each vehicle 50 by virtue of the surface information including the position information of a position in the home vicinity of the user of each vehicle 50. On the other hand, by outputting the position information of a position that is separated by the predetermined distance or greater, from a position in the home vicinity of the user, and subsequent positions following the position, it is possible to know, for a user visiting a facility for example, by which route the user visits the facility and by which route the user returns after visiting the facility. That is, it is possible to know an outward route to visit the facility and a return route after visiting the facility. In other words, according to the present embodiment, it is possible to obtain an advantageous effect in that it is possible to generate and provide accurate vehicle position information and can withstand analysis that is desired by a person, while protecting personal information. Next, the following describes, with reference to a block diagram in FIG. 4, functional blocks that are included in the information provider 30.

As illustrated in FIG. 4, the information provider 30 includes a control unit 31, a storage 32, and a communication unit 33.

The control unit 31 includes an arithmetic processing unit such as a microprocessor, and controls each unit that constitutes the information provider 30. The details of the control unit 31 are described later.

The storage 32 is configured with a semiconductor memory or the like, and stores various information such as programs such as control programs called firmware and operating systems and programs that perform a providing process of the position information, and also map information. The figure illustrates, as information that is stored in the storage 12, a map information storage 321 that stores the map information, a position information database 322 that stores the position information for each vehicle 50, and a departure/arrival point position information table 323 that stores parking position information for each vehicle 50.

The map information that is stored in the map information storage 321 includes, for each facility of a plurality of facilities, identification information (a facility ID) of the facility, a name of the facility, a facility type (and/or genre) that relates to a type of the facility, a telephone number, an address, operating hours, a center position of the facility (for example, longitude and latitude information), and the like. Here, the facility type indicates, for example, a business category of a facility such as a convenience store, a hospital, or a car dealer. In addition to the map information, the storage 32 may also include road network data that includes road information, map data for displaying that displays backgrounds such as roads and road maps, position information and type information of nodes (for example, an intersection, a bending point, an end point, or the like), position information and type information of links that are routes connecting the nodes, link cost data relating to cost information (for example, distance, required time, and the like) of all the links, and the like.

The map information may be configured to be stored in the map information storage 321 in advance, or may be configured to be appropriately downloaded from a server (not shown) or the like that is connected to the communication network 60 as necessary. Furthermore, the map information may be appropriately modified in accordance with user input or the like.

The position information database 322 is constructed based on the position information 121 and mobile object ID 122 that are received from the vehicle-mounted navigation apparatus 10 and the position information 221 and mobile object ID 222 that are received from the portable terminal 20. The position information database 322 is constructed and updated by each functional block included in the control unit 31. The details of the position information database 322 are described later.

As described later, the departure/arrival point position information table 323 stores, as a parking position of the vehicle 50 in association with identification information of the vehicle 50, position information of a position that is determined by the departure/arrival point position information recording unit 312 to be a position in which the vehicle 50 has parked. At this time, the departure/arrival point position information table 323 may match and store, in addition to the parking position, a parking time that includes date/time information of the parking position.

In the following description, in a case in which the position information 121 and the position information 221 are described without distinction, the reference numerals are omitted, and the position information 121 and the position information 221 are referred to as “position information”. Similarly, in a case in which the mobile object ID 122 and the mobile object ID 222 are described without distinction, the reference numerals are omitted, and the mobile object ID 122 and the mobile object ID 222 are referred to as “mobile object ID”.

The communication unit 33 includes a DSP or the like, and achieves, in accordance with standards such as Long-Term Evolution (LTE), 4th Generation (4G), and 5th Generation (5G) and standards such as Wi-Fi (registered trademark), wireless communication and wired communication with another apparatus (for example, the vehicle-mounted navigation apparatus 10 and the portable terminal 20) via the communication network 60. The communication unit 33 is used, for example, to receive position information, user information, and mobile object ID that are transmitted from each of the vehicle-mounted navigation apparatus 10 and the portable terminal 20. However, the data transmitted and received between the communication unit 33 and the other device is not particularly limited, and other information may also be transmitted and received.

Next, the following describes the control unit 31 in detail. The control unit 31 is configured with a microprocessor that has a Central Processing Unit (CPU), Random access memory (RAM), Read Only Memory (ROM), Input/Output (I/O), and the like. The CPU executes each program read from the ROM or the storage 32, and, during execution, reads information from the RAM, the ROM, and the storage 32, writes information to the RAM and the storage 32, and transmits and receives signals to and from the communication unit 33, the sensor unit 34, the display unit 35, and the input unit 36. Moreover, in this way, the hardware and the software (program) cooperate to achieve the processing in the preferred embodiment of the present disclosure.

The control unit 31 includes, as functional blocks, a receiver 311, a departure/arrival point position information recording unit 312, a departure/arrival point position information generator 313, and a position information outputter 314.

The receiver 311 is configured to receive position information that is consecutive, together with time information, from a plurality of vehicles 50. More specifically, the receiver 311 is configured to update the position information database 322 based on the position information that is consecutive and the mobile object ID that are received from the mobile object via the communication unit 33.

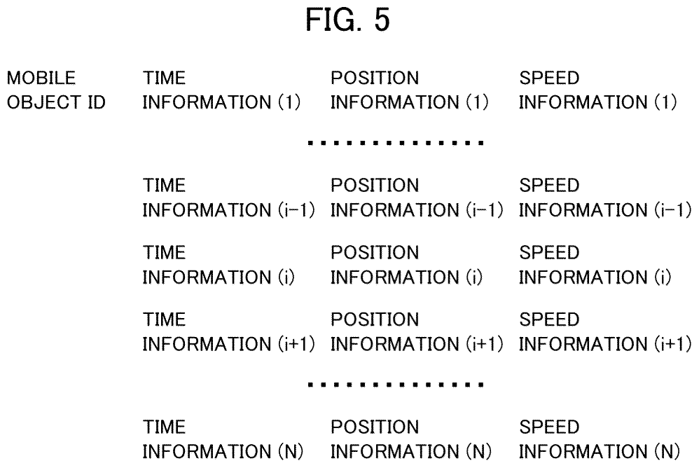

The following describes, with reference to FIG. 5, an example of a data structure of the position information database 322. As illustrated in FIG. 5, the position information database 322 may store, for each vehicle 50, “speed information” in addition to “mobile object ID”, “travel transition”, and “position information that is consecutive and time information from the vehicle 50” that are received by the receiver 311.

As described above, the “mobile object ID” in the position information database 322 identifies the vehicle-mounted navigation apparatus 10, the portable terminal 20, and the vehicle 50 on which the vehicle-mounted navigation apparatus 10 and the portable terminal 20 are mounted. The vehicle-mounted navigation apparatus 10, the portable terminal 20, and the vehicle 50 are transmission sources of the position information and the like. The “travel transition” in the position information database 322 refers to all the position information that is consecutive and received from the mobile object from the start of transmission of the position information or the like to the current time. By virtue of all the position information that is consecutive, it is possible to specify the parking position information that includes the parking position, the parking date/time, and the like. The travel transition also includes the time information at which positioning of the position information was performed. Furthermore, in a case in which the speed information, together with the position information, is transmitted from the mobile object, the speed information that is received is stored in association with the time information and the position information.

The receiver 311 may update the position information database 322 by storing, each time the transmission of the position information and identification information from the vehicle-mounted navigation apparatus 10 and the portable terminal 20 starts and then ends, the above-described information in a new field based on the received position information and identification information.

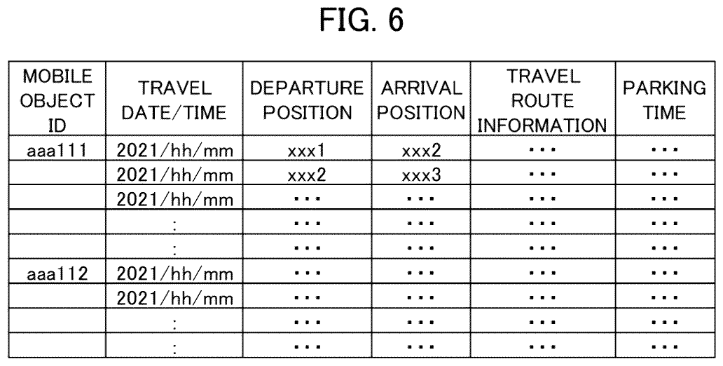

Based on the position information database 322, the departure/arrival point position information recording unit 312 stores, in the departure/arrival point position information table 323 and as the departure point position of the vehicle and in association with the identification information of the vehicle 50, the position information of a position at which the vehicle 50 first starts on each day. FIG. 6 is a diagram that illustrates an example of a data structure of the departure/arrival point position information table 323. As shown in FIG. 6, the departure/arrival point position information table 323 may, for each vehicle 50, store at least one of the “mobile object ID”, the “travel date/time”, the “departure point position information”, the “arrival point position information”, the “travel route information” or the “parking time”.

Specifically, the departure/arrival point position information recording unit 312 may match and store, together with the departure point position information and the arrival point position information, date/time information at the departure point position and parking time at the arrival point. The parking time may be a parking time at the departure point instead of the parking time at the arrival point. Further, the departure/arrival point position information table 323 may store the parking time that is determined in accordance with the departure point and the parking time at the arrival point. In addition, in a case in which the mobile object (vehicle 50) departs from an arrival point that is described later, the departure/arrival point position information recording unit 312 uses the arrival point as a new departure point and records, in the departure/arrival point position information table 323, the position information that changes at discrete times until the next arrival point as the travel route information. Further, in a case in which it is determined, based on the position information database 322, that there is no change in the vehicle position information for a predetermined time or longer, the departure/arrival point position information recording unit 312 determines that the mobile object (vehicle 50) is parked. In a case in which the departure/arrival point position information recording unit 312 determines that the vehicle 50 is parked, the departure/arrival point position information recording unit 312 calculates the parking time of the mobile object (vehicle 50). The departure/arrival point position information recording unit 312 stores, in the departure/arrival point position information table 323 as the arrival point position of the vehicle and in association with the identification information of the vehicle 50, the position information of a position that is determined to be a position in which the vehicle 50 has parked. Further, the departure/arrival point position information recording unit 312 is configured to match and store the departure point/arrival point position information together with the parking time that includes the date/time information at the parking position.

More specifically, for example, in a case in which the transmission of the position information or the like starts, the position information is received, and then no position information is transmitted for a predetermined time, the departure/arrival point position information recording unit 312 may determine the position that corresponds to the position information that was received last to be the arrival point position. In this case, the departure/arrival point position information recording unit 312 may calculate, as the parking time of the vehicle 50, a predetermined time during which no position information was transmitted. Further, in a case in which a position that corresponds to the position information to be transmitted does not change for a certain period of time or more, this position may be determined to be the arrival point position. In this case, the departure/arrival point position information recording unit 312 may calculate, as the parking time of the vehicle 50, the time during which the position does not change. Further, in a case in which an interval between times at which the position information of adjacent positions in the position information that is consecutive and is received from the vehicle 50 exceeds a first time that is set in advance and any of the speed information of the position information of the adjacent positions is lower than or equal to a predetermined speed V₀ that is set in advance, the departure/arrival point position information recording unit 312 may determine that the vehicle has stopped. In this case, the departure/arrival point position information recording unit 312 may calculate, as the parking time of the vehicle 50, the interval between times at each time the position information of an adjacent position is measured. Here, the predetermined speed V₀ may be, for example, about a speed at a time just before the vehicle stops at a parking lot. Alternatively, the predetermined speed V₀ may be 0 km/h. The predetermined speed V₀ may be set according to characteristics of each vehicle 50 (characteristics of the driver while driving). By doing so, even in a case in which, for example, the departure/arrival point position information recording unit 312 is a device that cannot transmit position information when the ignition switch is turned on and/or when the ignition is turned off, it is possible to specify information that can be regarded as parking information. In a case in which the transmission of the position information of the vehicle 50 stops by virtue of the ignition switch of the vehicle 50 turning off, for example, as with the vehicle-mounted navigation apparatus 10 in existing vehicles that have an engine, the current position transmitted immediately before the reception of the position information of the vehicle 50 stops may be used as the parking position. In this case, the departure/arrival point position information recording unit 312 may calculate, as the parking time of the vehicle 50, a time period from a stop of the transmission of the position information of the vehicle 50 to a start of the transmission of the position information of the vehicle 50. Similarly, in a case in which the transmission of the position information of the vehicle 50 starts by virtue of the ignition of the vehicle 50 turning on, for example, as with the vehicle-mounted navigation apparatus 10 in existing vehicles that have an engine, the current position when the reception of the position information of the vehicle 50 starts may be used as the parking position. In this case, before the reception of the position information of the vehicle 50 starts, the departure/arrival point position information recording unit 312 may calculate, as the parking time of the vehicle 50, a time difference from a time when the transmission of the position information of the vehicle 50 stopped. Further, in a case in which stop signal information can be transmitted such with an electric vehicle, and even in a case in which the vehicle 50 has stopped, a most recent position information of the position information of the vehicle 50 or the current position that is indicated by the stop signal information may be used as the parking position. In this case, the departure/arrival point position information recording unit 312 may calculate, as the parking time of the vehicle 50, a time period from reception of the stop signal information to reception of an activation signal information or the position information. Similarly, in a case in which the vehicle 50 can transmit the activation signal information at a time of activation of the vehicle 50, such as an electric vehicle, a current position that is indicated by the activation signal information may be used as the parking position. In this case, the departure/arrival point position information recording unit 312 may calculate, as the parking time of the vehicle 50, a time difference from a time at which the stop signal information from the vehicle 50 that was before reception of the activation signal information was received or from when the time when the position signal was received last.

The following describes the departure/arrival point position information generator 313. The departure/arrival point position information generator 313 is configured to calculate, based on the departure/arrival point position information table 323 in which the departure point position information and arrival point position information of each mobile object (vehicle 50) of the plurality of mobile object are recorded, a highest frequency value for the departure/arrival point position (also referred to as “most frequent departure/arrival point position”) of each mobile object (vehicle 50) in a predetermined period and generates, as the most frequent departure/arrival point position information, surface information that includes the position information of a position that has the highest frequency value. Here, the departure/arrival point position of the mobile object (vehicle 50) indicates a position (arrival position) at which the vehicle is parked during a travel of the mobile object (vehicle 50) and is also a position (departure position) at which the vehicle departs after parking. As is described in modification examples that are described later, not only the most frequent departure/arrival point position, but also a position of, for example, a workplace, a school, or the like of the user of the mobile object (vehicle 50) may be treated as position information to be protected as personal information of the user of the mobile object (vehicle 50). The details thereof are described later.

A degree of “matching” of similar positions may be arbitrarily determined. For example, in a case in which the vehicle-mounted navigation apparatus 10 or the portable terminal 20 can accurately measure the position information, the range within which matching is determined may be decreased. On the other hand, in a case in which the vehicle-mounted navigation apparatus 10 or the portable terminal 20 cannot measure the position information with a high degree of accuracy, the range within which matching is determined may be increased. In other words, stop positions may be determined to match even when the position slightly shifts. In this way and for each mobile object (vehicle 50), the departure/arrival point position information generator 313 calculates the most frequent departure/arrival point position, associates the most frequent departure/arrival point position that is calculated with the mobile object ID as a position in the home vicinity of the user of the mobile object (vehicle 50), and records the result in the storage 32. In a case in which the departure position is determined to be a position of a rental facility, the departure position is not a center for daily life of the user of the mobile object, and therefore the departure position may be recorded as “car rental”. In this way, the departure/arrival point position information generator 313 can specify position information that relates to the personal information of a position in the home vicinity of the user of each vehicle 50.

Next, the departure/arrival point position information generator 313 generates, for each mobile object (vehicle 50), surface information based on the most frequent departure/arrival point position that is specified. Specifically, for each mobile object (vehicle 50), the departure/arrival point position information generator 313 may generate for example, as the surface information, the mesh of a predetermined area or greater that includes the most frequent departure/arrival point position that is specified. In a case in which the mesh is generated as surface information, the mesh may include, for example, a predetermined number or greater of home positions of the vehicles 50. Further, for each mobile object (each vehicle 50), the departure/arrival point position information generator 313 may generate, as the surface information, an administrative section that is predetermined and includes the most frequent departure/arrival point position that is specified. Here, as the administrative section, an administrative section that includes a predetermined number or more of households is desirable. In a case in which analysis is performed based on, for example, the “travel route information with protected personal information” by using the administrative section as the surface information, it is possible to perform various analyses based on the administrative section, such as analyzing, for each administrative section, a trend that relates to the number of the vehicles 50 that move from an administrative section at a home position to a predetermined position, a predetermined facility, or the like, and analyzing, for each administrative section, a trend that relates to the number of the vehicles 50 that move from the predetermined position, the predetermined facility, or the like the administrative section at a home position. The above describes a method of generating surface information for protecting position information that relates to the personal information of the home vicinity of the user of the mobile object (vehicle 50).

The position information outputter 314 is configured to output, for each mobile object of the plurality of mobile object, the surface information and the position information of the positions that are separated by the predetermined distance or greater, from the position that has the highest frequency value, and subsequent positions following the position. Specifically, the position information outputter 314 generates, for each mobile object ID, a travel route from the departure point to the arrival point for each travel as travel route information based on position information that changes at discrete times and is received during the travel. As the travel route information, position information to be picked up may be based on a predetermined time interval that is set in advance. Here, the time interval may be a parameter value that is set by a user who uses the vehicle position information to perform various analyses. At this time, in a case in which the departure point position and the arrival point position are the most frequent departure/arrival point position that is described above for the mobile object (vehicle 50), the departure point position and/or the arrival point position that corresponds to the most frequent departure/arrival point position is replaced with the surface information described above. At the same time, the position information outputter 314 picks up, as the travel route information, position information of each position that is separated by the predetermined distance or greater, from the most frequent departure/arrival point position, and subsequent positions following the position. By doing so, it is possible to prevent a position of the mobile object (vehicle 50) in the home vicinity of the user from being estimated. In addition, a position that is separated by a predetermined distance from the most frequent departure/arrival point position may be a position that is separated from the surface information that corresponds to the most frequent departure/arrival point position. Specifically, for example, the position information outputter 314 may pick up, from position information located outside the surface information, position information that changes at discrete times, that constitutes the travel route information, and that is position information of positions that are separated by the predetermined distance or greater, from the most frequent departure/arrival point position, and subsequent positions following the position. By doing so, it is possible to protect personal information even further.

Next, the position information outputter 314 converts each mobile object ID into a random value (referred to as “temporary mobile object ID”) by virtue of, for example, a one-way function so that personal information is unable to be specified from the mobile object ID of each mobile object (vehicle 50). In this way, it is possible to prevent the mobile object ID, that serves as personal information that specifies an individual, from being estimated from the “temporary mobile object ID”, and the possibility of leakage of the personal information from the mobile object ID can be eliminated. The above describes a method of generating, for each of the provisional mobile object IDs of each mobile object (vehicle 50) in the predetermined period, travel route information in which personal information is protected (referred to as “travel route information with protected personal information”). The travel route information is generated by picking up, from the position information of a position that is separated by a predetermined distance or greater, from the most frequent departure/arrival point position of the user, and subsequent positions following the position, position information that changes at discrete times and that constitutes the travel route information from the departure point to the arrival point and, in a case in which the departure point and arrival point are the most frequent departure/arrival point position of the user, picking up, instead of the position information, surface information that corresponds to the position information.

The position information outputter 314 outputs, for each of the provisional mobile object IDs of each mobile object (vehicle 50) in the predetermined period, and records, to the storage 32, the travel route information with protected personal information from the departure point to the arrival point.

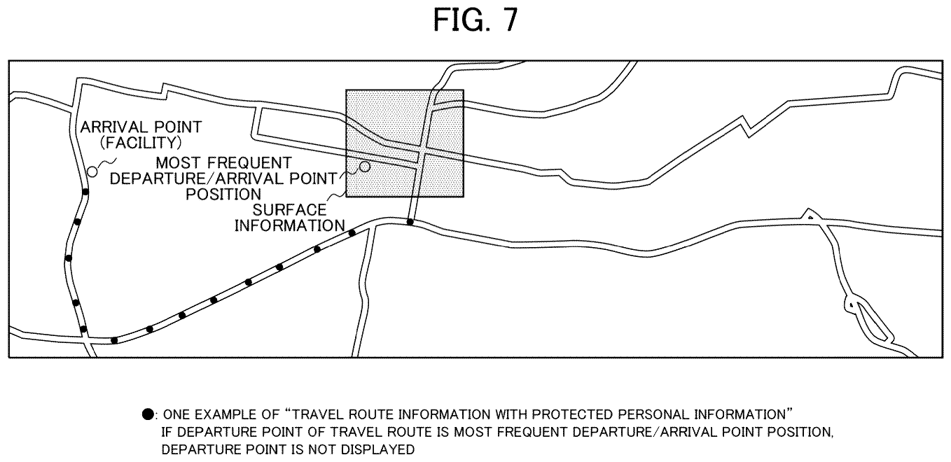

FIG. 7 is a diagram that illustrates an example of a display of travel route information with protected personal information. As illustrated in FIG. 7 and as described above, the position information outputter 314 may output, to the display device of the information provider 30 or in a superimposed manner on the map information, the information analyzer 40, or the like, the travel route information with protected personal information. By doing so, it is possible to make, for each mobile object (vehicle 50), the travel route information from the departure point to the arrival point visible on the map while protecting while protecting position information that relates to the personal information of the home vicinity of the user of the mobile object (vehicle 50).

Further, the position information outputter 314 may provide, to the information analyzer 40, the travel route information with protected personal information. By doing so, the information analyzer 40 can perform various well-known analyses in which the travel route information is used. As described above, it is possible to provide vehicle position information that can withstand analysis, while protecting position information that relates to the personal information of the home vicinity of the user of the mobile object (vehicle 50). The above describes a method of providing the vehicle position information with protected personal information.

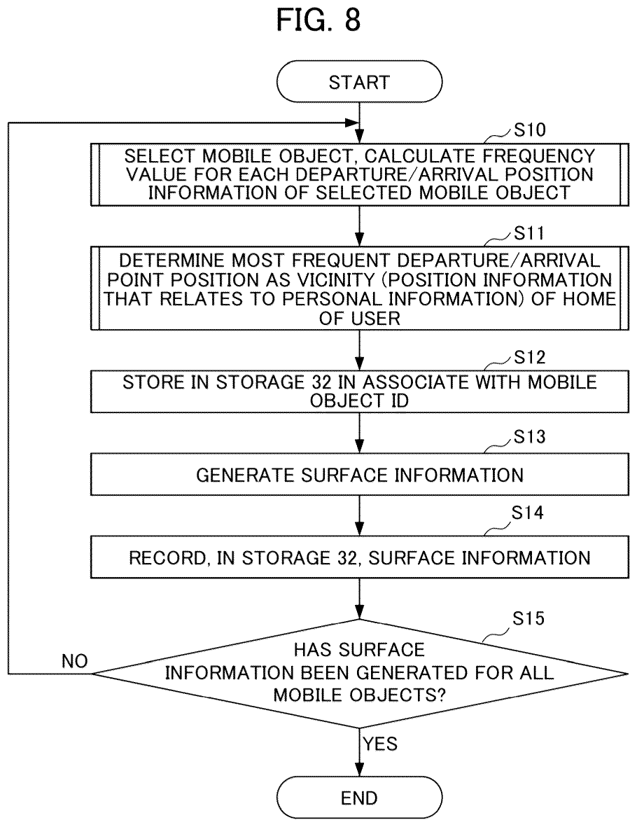

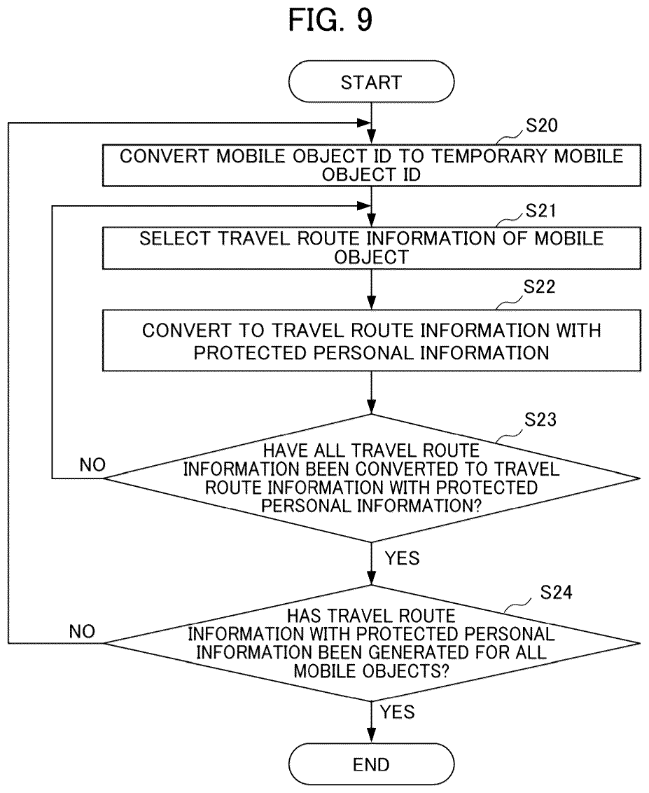

The following describes, with reference to flowcharts in FIGS. 8 and 9, the operation of the preferred embodiment of the present disclosure. Here, FIG. 8 is a flowchart that illustrates an operation of generating, for one mobile object (vehicle 50), surface information, in control unit 11. Specifically, FIG. 8 is a flowchart that illustrates an operation of calculating the most frequent departure/arrival point position of one mobile object (vehicle 50), specifying the calculated most frequent departure/arrival point position as the home vicinity of the user of the mobile object (vehicle 50), and generating the surface information. FIG. 9 is a flowchart that illustrates, for each mobile object (vehicle 50), an operation of generating travel route information with protected personal information. Further, FIG. 9 is a flowchart that illustrates, for one mobile object (vehicle 50), an operation of generating the travel route information with protected personal information. In addition, an operating process of the information provider 30 (receiver 311) receiving, from each mobile object (vehicle 50), the identification information, the position information, the time information, and the like of the mobile object (vehicle 50) to create and update the position information database 322, and an operating process of the information provider 30 (departure/arrival point position information recording unit 312) determining, from the travel transition of the position information of each mobile object (vehicle 50), the parking information of each mobile object (vehicle 50) and determining the departure point position information, the arrival point position information, a parking time, a departure time, an arrival time, and the like to create and update the departure/arrival point position information table 323 are publicly known to a person skilled in the art, and detailed descriptions thereof are omitted. First, the following describes an operation of generating surface information for each mobile object (vehicle 50).

Referring to FIG. 8, in step S10, the information provider 30 (departure/arrival point position information generator 313) selects one mobile object ID based on the departure/arrival point position information table 323 and calculates a frequency for all departure/arrival point positions of the mobile object (vehicle 50) that corresponds to the mobile object ID in the predetermined period. A determination of whether the position information is the same is based on the degree of “matching” that is set in advance as described above.

In step S11, the information provider 30 (departure/arrival point position information generator 313) selects a position of the departure/arrival point position that has a frequency with a large value and determines (specifies) the position as the home vicinity of the user of the mobile object (vehicle 50). Hereinafter, the position determined (specified) in step S11 is also referred to as “position information that relates to personal information”.

In step S12, the information provider 30 (departure/arrival point position information generator 313) stores, in the storage 32 in association with the mobile object ID, the “position information that relates to personal information” that was determined (specified) in step S11.

In step S13, the information provider 30 (departure/arrival point position information generator 313) generates surface information based on the “position information that relates to personal information” that was determined (specified) in step S11. Here, as the surface information, a region of a predetermined range that includes the position, for example the mesh of a predetermined area or greater that includes the position or the administrative section that includes the position, may be generated as described above.

In step S14, the information provider 30 (departure/arrival point position information generator 313) stores, in the storage 32 in association with the mobile object ID, the surface information that includes the “position information that relates to personal information” that was determined (specified) in step S13.

In step S15, the information provider 30 (departure/arrival point position information generator 313) determines whether surface information that corresponds to each mobile object of all the mobile objects (vehicle 50) has been generated. In a case in which the surface information that corresponds to each mobile object of all the mobile objects (vehicle 50) has been generated (YES), the processing ends. In a case in which the surface information that corresponds to each mobile object of all mobile objects (vehicle 50) has not been generated (NO), the process proceeds to step S10. By virtue of the above-described operation, surface information that corresponds to each mobile object can be generated for all mobile objects (vehicle 50).

Next, the following describes, with reference to the flowchart in FIG. 9, the operation for generating the travel route information with protected personal information of the mobile object (vehicle 50).

Referring to FIG. 9, in step S20, the information provider 30 (position information outputter 314) selects one mobile object ID and converts, by virtue of, for example, a one-way function, the mobile object ID into a random value (referred to as “temporary mobile object ID”).

In step S21, the information provider 30 (position information outputter 314) selects one piece of travel route information that relates to the mobile object ID.

In step S22, the information provider 30 (position information outputter 314) converts, into “move route information with protected personal information”, the piece of travel route information that relates to the mobile object ID that was selected in step S21 and stores the “move route information with protected personal information” in the storage 32 in association with the provisional mobile object ID.

In step S23, the information provider 30 (position information outputter 314) determines whether all of the travel route information of the mobile object (vehicle 50) that corresponds to the mobile object ID in a predetermined period has been converted into “move route information with protected personal information”. In a case in which all of the travel route information of the mobile object (vehicle 50) that corresponds to the mobile object ID has been converted (YES), the process proceeds to step S24. In a case in which all of the travel route information of the mobile object (vehicle 50) that corresponds to the mobile object ID has not been converted (NO), the process proceeds to step S21.

In step S24, the information provider 30 (position information outputter 314) determines whether the “movement route information with protected personal information” has been generated for all mobile objects (vehicle 50). In a case in which the “movement route information with protected personal information” has been generated for all mobile objects (vehicle 50) (YES), the process ends. In a case in which the “movement route information with protected personal information” has not been generated for all mobile objects (vehicle 50) (NO), the process proceeds to step S20. By virtue of the above-described operation, “movement route information with protected personal information” that corresponds to each mobile object can be generated for all mobile objects (vehicle 50).

As described above, according to the preferred embodiment of the present disclosure, it is possible to obtain an advantageous effect in that it is possible to provide the accurate vehicle position information (the travel route information from the departure point to the arrival point) and can withstand the various analyses, while protecting the position information that relates to the personal information of the home vicinity of the user of the mobile object. Furthermore, by virtue of treating the surface information as the mesh of a predetermined area or greater or an administrative section, and by virtue of making the position information that is included in the travel route information from the departure point to the arrival point to be only position information that is separated from the surface information, it is possible to obtain an advantageous effect in that it is possible to further protect the personal information. Further, by outputting, in a superimposed manner on the map information, the travel route information with protected personal information, it is possible to obtain an advantageous effect in that it is possible to make the vehicle position information (travel route information) of the mobile object visible on the map, while protecting the position information that relates to the personal information of the home vicinity of the user of the mobile object.

Each of the devices included in the navigation system that is described above can also be achieved by hardware, software, or a combination thereof. Further, a navigation method executed by cooperation of each device that is included in the navigation system described above can also be achieved by hardware, software, or a combination thereof. Here, “achieved by software” means achieved by a computer reading and executing a program.

The program may be stored using various types of non-transitory computer-readable media and provided to a computer. Non-transitory computer-readable media includes various types of tangible storage media. Examples of non-transitory computer-readable media include magnetic recording media (For example, flexible disks, magnetic tapes, hard disk drives, etc.), magneto-optical recording media (for example, magneto-optical disks), CD-ROMs (read-only Memory), CD-Rs, CD-R/Ws, semiconductor memory (For example, a mask ROM, a programmable ROM (PROM), an erasable PROM (EPROM), a flash ROM, and a random-access memory (RAM)). The program may also be provided to a computer by various types of transitory computer readable media. Examples of transitory computer-readable media include electrical signals, optical signals, and electromagnetic waves. The transitory computer-readable medium can provide the program to the computer via wired or wireless communication paths such as electric wires and optical fibers.

Although the above-described embodiments are preferred embodiments of the present disclosure, the scope of the present disclosure is not limited to the above-described embodiments, and various modifications can be made without departing from the gist of the present disclosure.

In the preferred embodiment of the present disclosure, the most frequent departure/arrival point position in the predetermined period of the mobile object (vehicle 50) is specified as the home vicinity of the user of the mobile object (vehicle 50), the surface information is generated to protect the most frequent departure/arrival point position as personal information, and a position to be protected as personal information are not limited to the most frequent departure/arrival point position. In addition, in a case in which, in the predetermined period, the departure point position, for example, is frequently a departure position that the user initially departs from every day, the departure/arrival point position information generator 313 may specify the departure point position (excluding a rental car facility, a taxi facility, and the like) as the home position of the user of the mobile object (vehicle 50) and specify the departure point position as a position to be protected as personal information. The departure/arrival point position information generator 313 may still make the same specification even in a case in which the departure point position of each mobile object (vehicle 50) is not the most frequent departure/arrival point position. Further, in a case in which, in the predetermined period, the arrival point position of each mobile object (vehicle 50), for example, is frequently a point at which the mobile object (vehicle 50) arrives after moving from the home vicinity of the user of the mobile object (vehicle 50) that was specified, stays at the arrival point position for a long time, and then moves from the arrival point position to the home vicinity of the user of the mobile object (vehicle 50) that was specified, and in a case in which the arrival point position can, by comparison with the map information, be specified as a workplace, a school, or the like of the user, the departure/arrival point position information generator unit 313 may specify the arrival point position as a position to be protected as personal information. The departure/arrival point position information generator 313 may still make the same specification even in a case in which the arrival point position is not the most frequent departure/arrival point position. In addition, the departure/arrival point position information generator 313 may also specify a position at which the mobile object (vehicle 50) is frequently parked for a long time of one day, for example, from a previous day to a following day, as a home position of the user of the mobile object (vehicle 50) and may specify the position as a position to be protected as personal information.

As described above in step S11 of the flowchart that illustrates the operation of generating the surface information of each mobile object (vehicle 50) that is illustrated in FIG. 8, in a case in which a position other than the frequency value departure/arrival point position is specified as a position to be protected as personal information, the information provider 30 (departure/arrival point position information generator 313) may specify the position to be protected as personal information by the method described above. Further, in step S13, the departure/arrival point position information generator 313 may generate the surface information based on the “position information that relates to the personal information” determined (specified) in step S11.

Further, in step S22 of the flowchart that illustrates, for each mobile object (vehicle 50), an operation of generating travel route information with protected personal information that is illustrated in FIG. 9 and in a case in which at least one of the departure position and the arrival position in the travel route information that relates to the mobile object ID corresponds to the “position information that relates to the personal information”, the at least one of the departure position and the arrival position that corresponds may be replaced with the “position information that relates to the personal information” surface information. In this way, not only a position in a home vicinity of the user of mobile object (vehicle 50) but also a position in a workplace vicinity or a position in a school vicinity may be protected as personal information.

For example, functional configurations in FIG. 2, FIG. 3, and FIG. 4 are merely illustrative and do not limit the functional configuration of the preferred embodiment. That is, it is sufficient for each device to have a function capable of executing, as a whole, a series of processes that relate to the overall information analysis function of the present disclosure, and which functional blocks are used to achieve this function are not particularly limited to the examples of FIGS. 2, 3, and 4.

As another modification example, the vehicle-mounted navigation apparatus 10 and the portable terminal 20 may be achieved by a device that has no route guidance function. That is, the route guidance function of the vehicle-mounted navigation apparatus 10 or the portable terminal 20 is not an essential configuration. In this case, the information provider 30 may further include a route guidance function, and the information provider 30 may perform route guidance by communicating with the vehicle-mounted navigation apparatus 10 or the portable terminal 20.

Furthermore, as yet another modification example, in the preferred embodiment that is described above, the information provider 30 has been described as being achieved by one server, and the information provider 30 may be achieved by a distributed process system that distributes each function of the information provider 30 to a plurality of servers as appropriate. Further, each function of the information provider 30 may be achieved in the cloud.

In the preferred embodiment that is described above, the information provider 30 is configured to receive, from each vehicle 50 via the communication unit 33, identification information, position information, time information, and the like of the vehicle 50. Further, the receiver 311 is configured to create and update, as appropriate, the position information database 322 based on the identification information, the position information, the time information, and the like that is received from each vehicle 50. Alternatively, a floating car data (FCD) server (provisional name) may be provided separately from the information provider 30, and the FDD server may receive, from each vehicle 50, identification information, the position information, the time information, and the like of the vehicle 50. In this case, the information provider 30 may acquire, from the FDD server, the position information of each vehicle and create and update, as appropriate, the position information database 322 (movement transition).

### EXPLANATION OF REFERENCE NUMERALS

1 information provision system
10 vehicle-mounted navigation apparatus
11, 21, 31, 41 control unit
111, 211 route guidance unit
112, 212 position information transmission unit
12, 22, 32, 42 storage
121, 221 position information
122, 222 type information
13, 23, 33, 43 communication unit
14, 24 sensor unit
15, 25, 44 display unit
16, 26, 45 input unit
20 portable terminal
27 short-range communication unit
30 information provider
311 receiver
312 departure/arrival point position information recording unit
313 departure/arrival point position information generator
314 position information outputter
32 storage
321 map information
322 position information database
323 departure/arrival point position information table
40 information analyzer
50, 50a, 50b vehicle
60 communication network

1. An information provider comprising:
a receiver that is configured to receive position information of a plurality of mobile objects;
a storage that is configured to store map information that includes a road map;
a departure/arrival point position information generator that is configured, for the plurality of mobile objects, to accumulate, for each mobile object of the plurality of mobile objects, the position information that changes discretely over time, calculate, for each mobile object of the plurality of mobile objects, a highest frequency value for the position information for each mobile object, and generate, as departure/arrival point position information, surface information that includes position information of a position that has the highest frequency value; and
a position information outputter that is configured, for the plurality of mobile objects, to output, for each mobile object of the plurality of mobile objects, the surface information and output the position information of a position that is separated by a predetermined distance or greater, from a position that has the highest frequency value, and subsequent positions following the position.

2. The information provider according to claim 1, wherein the surface information is a mesh of a predetermined area or greater.

3. The information provider according to claim 1, wherein the surface information is an administrative section.

4. The information provider according to claim 1, wherein the position that is separated by the predetermined distance or greater from the position that has the highest frequency value is a position that is separated from the surface information.

5. The information provider according to claim 1, wherein the position information outputter is configured to output, in a superimposed manner on the map information, the surface information and the position information of the positions that are separated by the predetermined distance or greater, from the position that has the highest frequency value, and subsequent positions following the position.

6. An information providing method that is performed by a computer, the method comprising:
a receiving step of receiving position information of a plurality of mobile objects;
a storing step of storing map information that includes a road map;
a departure/arrival point position information generating step of, for the plurality of mobile objects, accumulating, for each mobile object of the plurality of mobile objects, the position information that changes discretely over time, calculating, for each mobile object of the plurality of mobile objects, a highest frequency value for the position information for each mobile object, and generating, as departure/arrival point position information, surface information that includes position information of a position that has the highest frequency value; and
a position information outputting step of, for the plurality of mobile objects, outputting, for each mobile object of the plurality of mobile objects, the surface information and outputting the position information of a position that is separated, from a position that has the highest frequency value, by a predetermined distance or greater and subsequent positions following the position.
